(19) United States
(12) Patent Application Publication
(10) Pub. No.: US 2007/0274175 A1
(43) Pub. Date: Nov. 29, 2007

(54) Write-Once Disc, Method Of Using Write-Once Disc, And Data Recording And/Or Reproducing Apparatus

(76) Inventors: Sung-Hee Hwang, Seoul (KR); Jung-Wun Ko, Suwon-si (KR)

Correspondence Address: STEIN, MCEWEN & BUI, LLP, 1400 EYE STREET, NW, SUITE 300, WASHINGTON, DC, 20005, US

(21) Appl. No.: 10/573,997

(22) PCT Filed: Sep. 24, 2004
(86) PCT No.: PCT/KR04/02479

§ 371 Date: Mar. 30, 2006

(30) Foreign Application Priority Data
Sep. 30, 2003 (KR) 10-2003-0067917

(51) Int. Cl. G11B 5/66

(52) U.S. Cl. 369/47.1

(57) ABSTRACT

A data recording and/or reproducing apparatus and method of using a write-once disc are provided. The method includes: allocating at least one spare area to a data area of the recording layers; and dividing each spare area into a sub spare area and a temporary disc management area in the direction in which user data is recorded. Here, the size of the temporary disc management area is greater than or equal to 1/N (N is a real number) of the size of one spare area.

### CROSS-REFERENCE TO RELATED APPLICATIONS

This application claims the benefit of PCT International Patent Application No. PCT/KR2004/002479, filed Sep. 24, 2004, and Korean Patent Application No. 2003-67917, filed Sep. 30, 2003, in the Korean Intellectual Property Office, the disclosures of which are incorporated herein by reference.

### BACKGROUND OF THE INVENTION

1. Field of the Invention

The present invention relates to a write-once disc, and more particularly, to a write-once disc, a method of using the write-once disc, and a data recording and/or reproducing apparatus.

2. Related Art

A write-once disc is an information storage medium which can be recorded onto only once. Thus, a user cannot delete or change information recorded on the write-once disc.

Such a write-once disc is additionally provided with a spare area and a temporary disc management area (TDMA) in order to record information related to defect management or file system information including several kinds of information related to data recorded on the write-once disc in consideration of the characteristics of the write-once disc.

Defect management refers to re-recording a defective portion of user data recorded in a user data area of an information storage medium, such as a write-once disc, in a spare area in order to prevent loss of data caused by the defect.

The defect management method of the write-once disc will be explained in more detail as follows. A drive system records data on the write-once disc in predetermined units, and then verifies the recorded data using a verify-after-write method to find defective positions on the write-once disc. The drive system then re-records data from the defective positions in a spare area, and generates a temporary defect list (TDFL) indicating the defective positions and corresponding positions in the spare area, and a temporary disc definition structure (TDDS) indicating the position in which the TDFL is recorded.

The drive system stores the TDFL or TDDS in a memory, collects a predetermined amount of the TDFL or TDDS, and records the predetermined amount of the TDFL or TDDS in the TDMA. Continuous recording of data on the write-once disc contributes to updating the TDFL or TDDS recorded in the TDMA.

In addition, file system information updated due to recording of data in the spare area is recorded using the above-described defect management and a logical over-write function. The logical over-write function refers to the update of information recorded in a logical address by changing the physical address of a write-once disc corresponding to the logical address without changing the logical recording portion of the write-once disc, i.e., the logical address.

The update of the file system information on the write-once disc will be described in more detail as follows. The drive system checks whether data is recorded in a physical address of the write-once disc corresponding to a logical address of the file system information, in compliance with a file system update command of a host. When the drive system checks that the data has been recorded in the physical address, the drive system determines that the physical address area is a defective area and then records updated file system information in the spare area.

The above-described spare area is allocated within a data area during initialization of the write-once disc. An area outside the data area, i.e., a lead-in area or a lead-out area, includes at least one TDMA. However, a portion of the spare area may be allocated as a TDMA during the initialization of the write-once disc.

Also, when the amount of data to be recorded in the spare area is larger than expected, the spare area may be extended. However, the amount of data recorded in the spare area is proportional to the amount of data recorded in the TDMA. In other words, when the amount of data to be recorded in the spare area is large, an amount of data to be recorded in the TDMA increases. Thus, the spare area must be extended or reduced according to the size of the TDMA.

### SUMMARY OF THE INVENTION

The present invention provides a write-once disc, a method of using the write-once disc so as to further efficiently use a data area, and a data recording and/or reproducing apparatus.

Additional aspects and/or advantages of the invention will be set forth in part in the description which follows and, in part, will be obvious from the description, or may be learned by practice of the invention.

According to an aspect of the present invention, there is provided a method of using a write-once disc comprising at least one recording layer, including: allocating at least one spare area to a data area of the recording layers; and dividing each spare area into a sub spare area and a temporary disc management area in the direction in which user data is recorded. Here, the size of the temporary disc management area is greater than or equal to 1/N (where N is a real number) of the size of one spare area.

According to another aspect of the present invention, there is provided a data recording and/or reproducing apparatus comprising: a recording and/or reading unit which records data on and/or reads data from a write-once disc comprising at least one recording layer; and a controller which allocates at least one spare area to a data area of the recording layers, divides each spare area into a sub spare area and a temporary disc management area (TDMA) in the direction in which user data is recorded, and controls the recording and/or reading unit to record information on the position and/or size of each spare area and information on the position and/or size of the sub spare area and the temporary disc management area (TDMA) on the write-once disc. Here, the controller determines the size of the temporary disc management area to be greater than or equal to 1/N of the size of one spare area.

According to still another aspect of the present invention, there is provided a single recording layer write-once disc on which user data is recorded from the inside out, including a recording layer which comprises a data area. The data area includes a spare area which is allocated to an area ranging from a predetermined position of the data area to the last position of the data area and which is divided into a sub spare area and a temporary disc management area from the inside out. Here, the size of the temporary disc management area is greater than or equal to 1/N (N is a real number) of the size of the spare area.

According to yet another aspect of the present invention, there is provided a dual recording layer write-once disc including: a first recording layer on which user data is recorded using an opposite track path method; and a second recording layer which comprises a data area. Here, an area ranging from a predetermined position of the data area to the last position of the data area is allocated as a spare area which is divided into a sub spare area and a temporary disc management area from the outside in, and the size of the temporary disc management area is greater than or equal to 1/N (N is a real number) of the size of the spare area.

In addition to the example embodiments and aspects as described above, further aspects and embodiments of the present invention will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1A is a view showing the structure of a write-once disc according to an embodiment of the present invention;

FIG. 1B is a view showing the structure of a write-once disc according to another embodiment of the present invention;

FIG. 2 is a view showing the structure of a recording layer of a write-once disc according to an embodiment of the present invention;

FIGS. 3A and 3B are views showing the structure of a recording layer of a write-once disc in which spare areas are allocated to a data area, according to an embodiment of the present invention;

FIGS. 4A and 4B are views showing the sizes of spare area #2 and TDMA #2 shown in FIGS. 3A and 3B;

FIGS. 5A and 5B are views showing the structure of a recording layer L1 of a dual recording layer write-once disc in which spare areas and a TDMA are allocated to a data area, according to an embodiment of the present invention;

FIG. 6 is a block diagram of an example data recording and/or reproducing apparatus according to an embodiment of the present invention; and

FIG. 7 is a flowchart of a method of using a single recording layer write-once disc, according to an embodiment of the present invention.

### DETAILED DESCRIPTION OF EXAMPLE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

In accordance with example embodiments of the present invention, when a spare area is allocated to a data area during initialization of a write-once disc and then divided into a sub spare area and a TDMA, the sub spare area may be extended or reduced within a predetermined range according to the size of the TDMA, so as to more efficiently use the data area or the spare area of the write-once disc.

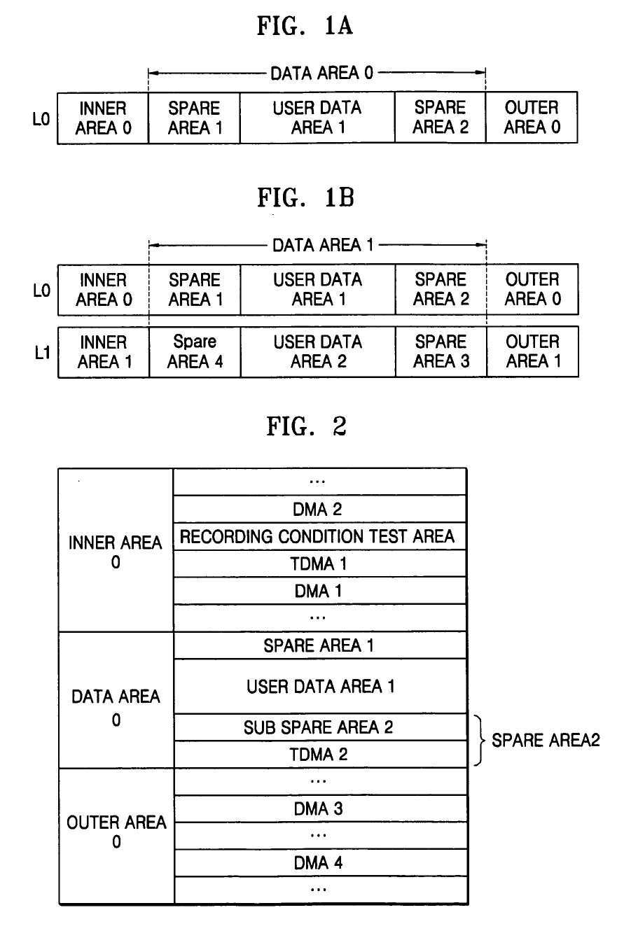

FIG. 1A is a view showing the structure of a write-once disc according to an embodiment of the present invention, and FIG. 1B is a view showing the structure of a write-once disc according to another embodiment of the present invention. FIG. 1A shows a structure of a write-once disc having a single recording layer L0, and FIG. 1B shows a structure of a write-once disc having a dual recording layer, i.e., recording layers L0 and L1.

Referring to FIG. 1A, the write-once disc having a single recording layer L0 includes an inner area 0, a data area 0, and an outer area 0. The data area 0 includes a spare area #1, a user data area 1, and a spare area #2. Referring to FIG. 1B, the dual recording layer write-once disc includes recording layers L0 and L1. Here, each of the recording layers L0 and L1 has the same structure as recording layer L0 of the single recording layer write-once disc shown in FIG. 1A.

FIG. 2 is a view showing the structure of an example recording layer of a write-once disc according to an embodiment of the present invention. Such an example recording layer may correspond to a recording layer L0 of the single recording layer write-once disc or a first recording layer L0 of the dual recording layer write-once disc. Referring to FIG. 2, a recording layer of the write-once disc includes an inner area 0, a data area 0, and an outer area 0. The inner area 0 includes disc management area #1 (DMA #1), a recording condition test area, a TDMA 1, and DMA #2. Data area 0 includes a spare area #1, a user data area 1, and a spare area #2. The spare area #2 is divided into a sub spare area #2 and a TDMA #2. The spare areas #1 and #2 are allocated to predetermined positions of the data area 0 during initialization of the write-once disc according to the selection of a user or the command of a drive system (not shown). The spare area #2 is divided into the sub spare area #2 and the TDMA #2 according to a selection of the user or a command of the drive system.

Here, a temporary disc management area (TDMA) refers to an area in which defect management information, temporary disc management information, and the like are recorded. The defect management information includes a TDFL and a TDDS, and the temporary disc management information includes a space bit map (SBM) for representing the data recording state of the write-once disc using different bit values, a last recorded address (LRA) of a user data area, and the like.

According to an aspect of the present invention, a spare area may be allocated to a data area and then divided into a sub spare area and a TDMA. Here, the temporary disc management information includes information as to whether the spare area has been allocated to the data area, information as to the position and size of the spare area, and information as to the positions and sizes of the sub spare area and the TDMA into which the spare area allocated to the data area is divided.

A disc management area (DMA) refers to an area in which final disc defect information and temporary disc management information recorded in a TDMA are recorded during finalization of the write-once disc.

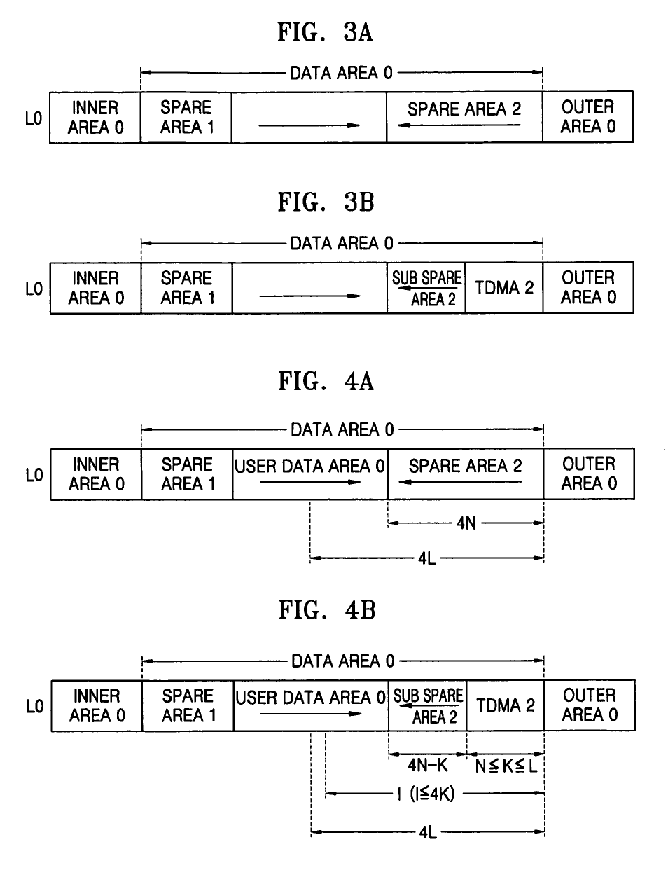

FIGS. 3A and 3B are views showing the structure of a recording layer L0 of a singe recording layer write-once disc or a dual recording layer write-once disc including a data area to which spare areas and a TDMA are allocated, according to an embodiment of the present invention. Referring to FIG. 3A, spare areas #1 and #2 are allocated to a data area 0 during initialization of the write-once disc. The remainder of the data area 0, except the spare areas #1 and #2, i.e., a user data area, is used from the inside out as shown in FIG. 3A. The spare area #1 is used from the inside out, while the spare area #2 is used from the outside in. If a spare area needs to be extended, the spare area #2 is used from the outside in.

In general, a spare area which replaces a defective area occupies about 5% of the entire capacity of a write-once disc. However, when updated file system information is recorded in the spare area using logical over-write (LOW) and defect management, the size of the spare area does not need to be larger. In accordance with example embodiments of the present invention, a spare area is allocated in advance during initialization of a write-once disc and extended within a predetermined range if necessary.

Referring to FIG. 3B, the spare areas #1 and #2 are allocated to the data area 0 as shown in FIG. 3A, and then the spare area #2 is divided into a sub spare area #2 and a TDMA #2.

FIGS. 4A and 4B are views showing the sizes of the spare area #2 and the TDMA #2 shown in FIGS. 3A and 3B.

In the present embodiment, the size of the TDMA #2 in the spare area #2 is greater than or equal to 1/4 of the size of the spare area #2. However, the ratio of the size of the TDMA #2 to the size of the spare area #2 is not limited to this and may vary.

Referring to FIG. 4A, the spare area #2 having the size of 4N is allocated to the end of the data area 0 during initialization of the write-once disc. Here, the size of an area refers to the number of error correction code (ECC) blocks or the amount of data that can be recorded in the area. In the present embodiment, the size of a specific area refers to the number of ECC blocks of the specific area. Here, 4L indicates the maximum size allocable to the spare area #2.

Referring to FIG. 4B, the spare area #2 is divided into the sub spare area #2 and the TDMA #2. The data area 0 is used from the inside out, while the sub spare area #2 is used from the outside in so as to be easily extended.

As previously described, the amount of data recorded in a spare area is proportional to the amount of data recorded in a TDMA. Thus, it is preferable that the size of the spare area is determined according to the size of the TDMA. In the present embodiment, as shown in FIG. 4B, the TDMA #2 has the size of K which is greater than or equal to N or less than or equal to L. In other words, the size of the TDMA #2 is greater than or equal to ¼ of the size of the spare area #2 or less than or equal to 1/4 of the maximum size allocable to the spare area #2. Thus, since the TDMA #2 has the size of K, the spare area #2 has the size of 4N-K.

After the spare area #2 is divided into the sub spare area #2 and the TDMA #2, the size of the TDMA #2 cannot vary. However, the sub spare area 2 may be extended inward or reduced outward. The extension of the sub spare area #2 is possible when data is not recorded in the user data area 0 adjacent to the sub spare area #2.

According to the present embodiment, the sub spare area #2 is extended according to the size of the TDMA #2. In other words, the sub spare area #2 is extended so that the sum of the sizes of the extended sub spare area #2 and the TDMA #2 does not exceed four (4) times the size of the TDMA #2. When the size of the TDMA #2 is 1/4 of the size of the spare area #2, i.e., N, the spare area #2 may not be extended.

If the amount of data to be recorded in a spare area is small but a user data area must be extended, the sub spare area #2 may be reduced. Here, the size of the spare area #2 is reduced to “0”.

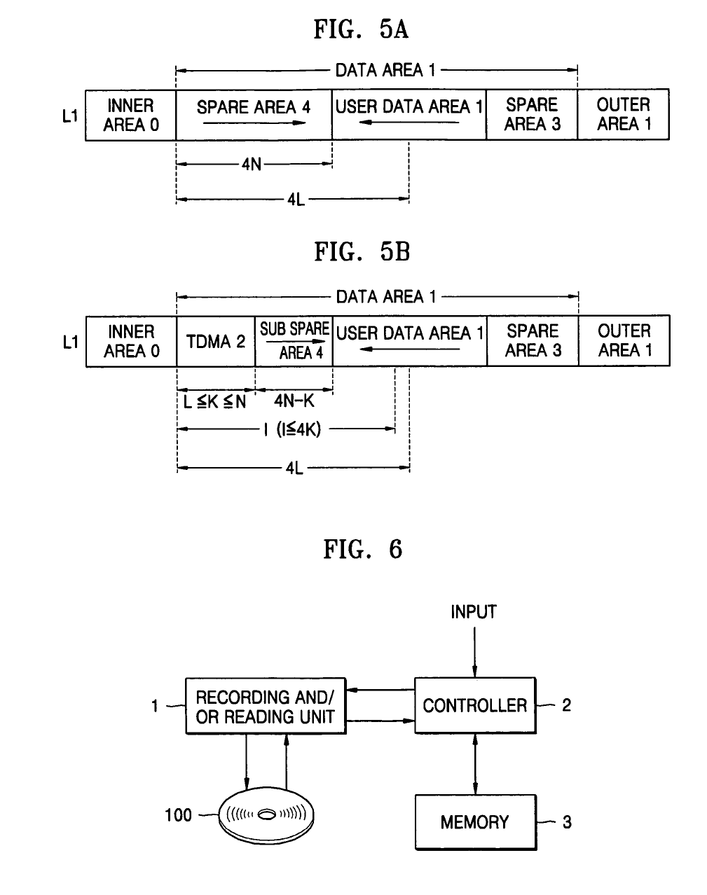

FIGS. 5A and 5B are views showing the structure of an example recording layer L1 of a dual recording layer write-once disc in which spare areas and a TDMA are allocated to a data area, according to an embodiment of the present invention.

In the case of the dual recording layer write-once disc according to the present embodiment, spare areas #1 and #2 may be allocated to a first recording layer L0, and spare areas #3 and #4 may be allocated to a second recording layer L1. Here, it is preferable that the spare area #4 is divided into a sub spare area #4 and a TDMA #2. All spare areas may be extended or reduced during the use of the write-once disc. However, the spare area #4 is most easily extended. Thus, in the present embodiment, the spare area #4 is divided into the sub spare area #4 and the TDMA #2. Here, like the case of the recording layer L0 shown in FIGS. 4A and 4B, the ratio of the size of the spare area #4 to the size of the TDMA #2 is 4:1.

The size range of the TDMA #2 in the spare area #4 and the range of extension or reduction of the sub spare area #4 are the same as in the embodiment of FIGS. 4A and 4B. However, the present embodiment is different from the embodiment of FIGS. 4A and 4B in that the spare area #4 is divided into the sub spare area #4 and the TDMA #2, the user data area 1 is used from the outside in, and the spare area #4 is used from the inside out.

FIG. 6 is a block diagram of an example data recording and/or reproducing apparatus according to an embodiment of the present invention. Referring to FIG. 6, the data recording and/or reproducing apparatus includes a recording and/or reading unit 1, a controller 2, and a memory 3. For purposes of brevity, the data recording and/or reproducing apparatus, albeit in whole or in part, can also be referred to as a drive system which can be internal (housed within a host) or external (housed in a separate box that connects to the host). Here, a write-once disc 100 may be the single recording layer write-once disc shown in FIG. 1A, or alternatively, the dual recording layer write-once disc shown in FIG. 1B.

The recording and/or reading unit 1 records data on and/or reproduces data from the write-once disc 100 under the control of the controller 2. Data to be recorded on the write-once disc 100 includes user data, a temporary defect list (TDFL), a temporary disc definition structure (TDDS), and so on. The TDDS includes information as to whether a spare area is allocated to a data area of the write-once disc 100, information as to the position and size of the spare area, and information as to the position and size of a sub spare area and a TDMA into which the spare area is divided.

The controller 2 controls the overall operation of the data recording and/or reproducing apparatus according to the present embodiment. In particular, the controller 2 allocates the spare area to the data area of the write-once disc 100 or divides the spare area into the sub spare area and the TDMA and records information on the allocation of the spare area to the data area on the write-once disc 100.

The memory 3 temporarily stores data read from the write-once disc 100 or various kinds of data to be recorded on the write-once disc 100.

A method of using a write-once disc adopting the data recording and/or reproducing apparatus shown in FIG. 6, according to an embodiment of the present invention, will now be explained herein below.

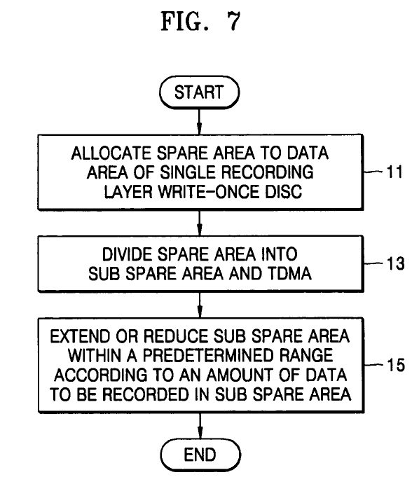

FIG. 7 is a flowchart of a method of using a single recording layer write-once disc, according to an embodiment of the present invention. Here, the method will be explained in detail with reference to the write-once disc shown in FIGS. 4A and 4B.

In operation 11, the controller 2 allocates an area, which ranges from a predetermined position of a data area of a recording layer of a single recording layer write-once disc to the last position of the data area, as a spare area according to the command of a user or a program. In the case of the write-once disc according to the embodiment shown in FIG. 4A, the spare areas #1 and #2 have been allocated to both ends of the data area 0. However, the spare area #2 allocated to the outside of the data area 0 is the main area of the present invention. The allocation of the spare area is performed before user data is recorded, i.e., when the write-once disc 100 is initialized.

When the spare area is allocated to the data area, the controller 2 controls the recording and/or reading unit 1 to record information for indicating that the spare area has been allocated to the data area and information as to the position and size of the spare area in a predetermined area of the write-once disc 100, for example, in a TDMA.

In operation 13, the controller 2 divides the spare area #2 into a sub spare area #2 and a TDMA #2 from the inside out according to the command of the user or a program. If user data is recorded in the data area from the inside out, the spare area #2 is divided into the sub spare area #2 and the TDMA #2 from the inside out, because adjoining the outer edge of a user data area with the sub spare area #2 allows the sub spare area #2 to be easily extended or reduced. In operation 13, it is preferable that the size of the TDMA #2 is greater than or equal to 1/N (where N is a real number) of the size of the spare area #2. Also, it is preferable that the size of the TDMA#2 is less than or equal to 1/N of the maximum size allocable to the sub spare area #2. In accordance with example embodiments of the present embodiment, N is 4.

Operation 11 and operation 13 are performed during initialization of the write-once disc 100. Since the user data is recorded on the write-once disc 100 after the write-once disc 100 is initialized, data is recorded in each of at least one spare area and at least one TDMA of the write-once disc 100.

If a spare area is needed when the spare areas 1 and 2 of the write-once disc 100 are almost full during the use of the write-once disc 100, in operation 15, the controller 2 extends the sub spare area #2 to be less than N times the size of the TDMA #2 toward the inner edge of the sub spare area #2 according to the command of the user or a program. Alternatively, if the user data area is to be extended due to the user data area filling up, in operation 15, the controller 2 reduces the size of the sub spare area #2. When the size of the sub spare area #2 is adjusted, the controller 2 controls the recording and/or reading unit 1 to record information on the adjusted position and/or size of the sub spare area #2 in a predetermined area of the write-once disc 100, for example, in a TDMA.

The method of using the write-once disc and the data recording and/or reproducing apparatus, according to the present invention, have been described with reference to the single recording layer write-once disc shown in FIGS. 4A and 4B, but may also be applied to a dual recording layer write-once disc. In other words, as shown in FIGS. 5A and 5B, the spare area #4 of a second recording layer L1 of the dual recording layer write-once disc may be divided into the TDMA #2 and the sub spare area #4, and then the sub spare area #4 may be extended or reduced as in the case of the above-described single recording layer write-once disc.

As described above, in a write-once disc, a method of using the write-once disc, and a data recording and/or reproducing apparatus, according to the present invention, a spare area and a TMDA can be allocated in the write-once disc. Also, the spare area can be extended or reduced according to the size of the TMDA. As a result, a data area of the write-once disc can be more efficiently used.

Various aspects and example embodiments of the present invention can be can be written as computer programs and can be implemented in general-use digital computers that execute the programs using a computer readable medium, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs), digital video discs (DVDs), or carrier waves (e.g., transmission through the Internet). The computer readable medium can also be distributed over network coupled computer systems so that the computer readable code is stored and executed in a distributed fashion.

While there have been illustrated and described what are considered to be example embodiments of the present invention, it will be understood by those skilled in the art that various changes in form and modification may be made therein, and equivalents may be substituted for elements thereof without departing from the spirit and scope of the present invention. As a result, many modifications, permutations, additions and sub-combinations may be made to adapt the teachings of the present invention to a particular situation without departing from the scope thereof. For example, while example embodiments focus on an optical disc serving as a write-once information storage medium, the scope of the present invention is not limited thereto. In addition, alternative embodiments of the invention can be implemented as a computer program product for use with a computer system. Such a computer program product can be, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device. In addition, a data recording and/or reproducing apparatus as shown in FIG. 6 can be implemented as part of a recording apparatus, or alternatively a single apparatus for performing recording and/or reproducing functions with respect to a storage medium. Likewise, the controller can be implemented as a chipset having firmware, or alternatively, a general or special purposed computer programmed to perform the methods as described, for example, with reference to FIG. 7. Accordingly, it is intended, therefore, that that present invention not be limited to the various example embodiments disclosed, but that the present invention includes all embodiments falling within the scope of the appended claims.

1. A method of using a write-once disc comprising at least one recording layer, the method comprising:
allocating at least one spare area to a data area of the at least one recording layer; and
dividing the at least one spare area into a sub spare area and a temporary disc management area,
wherein the size of the temporary disc management area is greater than or equal to 1/N (where N is a real number) of the size of the spare area.

2. The method as claimed in claim 1, wherein the size of the temporary disc management area is less than or equal to 1/N of the maximum size allocable to the spare area.

3. The method as claimed in claim 1, further comprising:
extending the sub spare area so that the sum of the sizes of the extended sub spare area and the temporary disc management area is less than or equal to N times the size of the temporary disc management area.

4. The method as claimed in claim 1, further comprising:
reducing the sub spare area in a direction in which the user data is recorded.

5. The method as claimed in claim 1, wherein each spare area is an area in which the user data is re-recorded, or updated file system information is recorded when the user data recorded in a user data area has a defect.

6. The method as claimed in claim 1, wherein the temporary disc management area is an area used to record information on temporary defect management and temporary disk management, including a temporary disc definition structure indicating defective positions.

7. The method as claimed in claim 1, wherein N is 4.

8. A data recording and/or reproducing apparatus comprising:
a recording and/or reading unit which records data on and/or reads data from a write-once disc comprising at least one recording layer; and
a controller which allocates at least one spare area to a data area of the at least one recording layer, divides the at least one spare area into a sub spare area and a temporary disc management area, and controls the recording and/or reading unit to record information on position and/or size of each spare area and information on position and/or size of the sub spare area and the temporary disc management area on the write-once disc,
wherein the size of the temporary disc management area to be s greater than or equal to 1/N of the size of one spare area.

9. The data recording and/or reproducing apparatus as claimed in claim 8, wherein the controller determines the size of the temporary disc management area to be less than or equal to 1/N of the maximum size allocable to one spare area.

10. The data recording and/or reproducing apparatus as claimed in claim 8, wherein the controller extends the sub spare area so that the sum of the sizes of the extended sub spare area and the temporary disc management area is less than or equal to N times the size of the temporary disc management area, and controls the recording and/or reading unit to record information on the size of the extended sub spare area on the write-once disc.

11. The data recording and/or reproducing apparatus as claimed in claim 8, wherein the controller reduces the sub spare area in a direction in which the user data is recorded, and controls the recording and/or reading unit to record information on the size of the reduced sub spare area on the write-once disc.

12. The data recording and/or reproducing apparatus as claimed in claim 8, wherein each spare area is an area in which the user data is re-recorded or updated file system information is recorded when the user data recorded in a user data area has a defect.

13. The data recording and/or reproducing apparatus as claimed in claim 8, wherein the temporary disc management area is an area in which a temporary disc definition structure is recorded.

14. The data recording and/or reproducing apparatus as claimed in claim 8, wherein N is 4.

15. A single recording layer write-once disc on which user data is recorded from the inside out, comprising:
a recording layer which comprises a data area,
wherein the data area comprises a spare area which is allocated to an area ranging from a predetermined position of the data area to the last position of the data area and which is divided into a sub spare area and a temporary disc management area from the inside out, and
wherein the size of the temporary disc management area is greater than or equal to 1/N (N is a real number) of the size of the spare area.

16. The single recording layer write-once disc as claimed in claim 15, wherein the size of the temporary disc management area is less than or equal to 1/N of the maximum size allocable to the spare area.

17. The single recording layer write-once disc as claimed in claim 15, wherein the sub spare area is an area which is extended inward so that the sum of the sizes of the extended sub spare area and the temporary disc management area is less than or equal to N times the size of the temporary disc management.

18. The single recording layer write-once disc as claimed in claim 15, wherein the sub spare area is an area which is reduced outward.

19. The single recording layer write-once disc as claimed in claim 15, wherein the spare area is an area in which the user data is re-recorded, or updated file system information is recorded when the user data recorded in a user data area has a defect.

20. The single recording layer write-once disc as claimed in claim 15, wherein the temporary disc management area is an area in which a temporary disc definition structure is recorded.

21. The single recording layer write-once disc as claimed in claim 15, wherein N is 4.

22. A dual recording layer write-once disc comprising:
a first recording layer on which user data is recorded using an opposite track path method; and
a second recording layer which comprises a data area,
wherein an area ranging from a predetermined position of the data area to the last position of the data area is allocated as a spare area which is divided into a sub spare area and a temporary disc management area from the outside in, and
wherein the size of the temporary disc management area is greater than or equal to 1/N (N is a real number) of the size of the spare area.

23. The dual recording layer write-once disc as claimed in claim 22, wherein the size of the temporary disc management area is less than or equal to 1/N of the maximum size allocable to the spare area.

24. The dual recording layer write-once disc as claimed in claim 22, wherein the sub spare area is an area which is extended outward so that the sum of the sizes of the extended sub spare area and the temporary disc management area is less than or equal to N times the size of the temporary disc management area.

25. The dual recording layer write-once disc as claimed in claim 22, wherein the sub spare area is an area which is reduced inward.

26. The dual recording layer write-once disc as claimed in claim 22, wherein the spare area is an area in which the user data is re-recorded, or updated file system information is recorded when the user data recorded in a user data area has a defect.

27. The dual recording layer write-once disc as claimed in claim 22, wherein the temporary disc management area is an area in which a temporary disc definition structure is recorded.

28. The dual recording layer write-once disc as claimed in claim 22, wherein N is 4.

29. The method as claimed in claim 1, further comprising extending the sub spare area in a direction opposite to that in which the user data is recorded.

30. The data recording and/or reproducing apparatus as claimed in claim 8, the controller extends the sub spare area in a direction opposite to that in which the user data is recorded.
